(19) United States
(12) Patent Application Publication
(10) Pub. No.: US 2007/0008243 A1
(43) Pub. Date: Jan. 11, 2007

(54) Plasma display panel (PDP)

(76) Inventor: Kwang-Jin Jeong, Yongin-si (KR)

Correspondence Address: Robert E. Bushnell, Suite 300, 1522 K Street, N.W., Washington, DC, 20005, US

(21) Appl. No.: 11/480,551

(22) Filed: Jul. 5, 2006

(30) Foreign Application Priority Data
Jul. 7, 2005 (KR) 10-2005-0061124

(51) Int. Cl. G09G 3/28

(52) U.S. Cl. 345/60

(57) ABSTRACT

A plasma display apparatus includes a Plasma Display Panel (PDP), a chassis base, a driver IC package, and cover plates. The chassis base has one side to which the PDP is attached and another side on which a Printed circuit Board Assembly (PBA) is mounted. The driver IC package is electrically connected to electrodes of the PDP and the PBA and has driver ICs for selectively supplying a voltage to the electrodes of the PDP mounted therein in response to a control signal of the PBA. The cover plates are disposed outside of the driver IC package, and they compress and fix the driver IC package to the chassis base. The cover plates have receiving holes for receiving the driver ICs of the driver IC package.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 7^{th} of July 2005 and there duly assigned Serial No. 10-2005-0061124.

### BACKGROUND OF THE INVENTION

1. Field of the Invention

The present invention relates to a plasma display apparatus. More particularly, the present invention relates to a plasma display apparatus that can hold a driver IC package more stably and can dissipate heat generated from driver ICs more effectively.

2. Description of the Related Art

In general, a plasma display apparatus is an apparatus for displaying an image in a Plasma Display Panel (PDP) using a plasma generated by the discharge of a gas.

The PDP includes electrodes that generate the discharge of a gas, corresponding to each discharge cell. The electrodes extend outward from the PDP in electrode terminal form, and are electrically connected to one another through a Flexible Printed Circuit (FPC) connected to a Printed circuit Board Assembly (PBA).

The FPC has driver ICs mounted thereon, forming one driver IC package. The driver IC package supplies an address voltage in order to form wall charges so that a turn-on discharge cell is selected from the discharge cells of the PDP according to a control signal of the PBA.

The driver IC package generally includes a Chip on Board (COB) in which driver ICs are mounted on a Printed Circuit Board (PCB), a Chip on Film (COF) in which an IC is directly mounted on a film constituting an FPC, and so on. Recently, a Tape Carrier Package (TCP) that is small in size and is inexpensive has generally been used as the driver IC package.

The TCP is usually fixed along one rear side of a chassis base by a reinforcement plate having a plate shape. In addition, a cover plate for compressing and fixing the reinforcement plate while protecting the TCP is provided outside the TCP.

In order for the PDP to represent 256 or more grayscales, an address discharge voltage must be supplied so that at least eight address discharges can be generated during 1/60 second, corresponding to 1 TV field. Therefore, a lot of heat is generated by the TCP.

The reinforcement plate serves as a heat dissipation plate that can dissipate heat generated by the TCP (mainly by the driver ICs) to the chassis base. Furthermore, a heat dissipating pad for dissipating heat to the outside through the cover plate is generally interposed between the cover plate and the driver ICs of the TCP.

The heat dissipating pad is preferably made of a metallic material with a high thermal conductivity so that it can radiate heat generated from the driver ICs of the TCP to the outside through the cover plate. However, to prevent the driver ICs from being damaged due to vibration and impact transferred through the cover plate, the heat dissipating pad is generally made of an insulating material.

Therefore, in the related art plasma display apparatus, parts (e.g., an FPC part) of the TCP other than the driver ICs are not in contact with the cover plate. Accordingly, a problem arises in that heat is not smoothly dissipated to the outside through the cover plate.

Because the heat dissipating pad that contacts the driver ICs is formed using a smooth insulating material in order to mitigate vibration and impact transferred through the cover plate, relatively little thermal conduction occurs. Accordingly, a problem arises because heat generated from the driver IC is not smoothly dissipated.

### SUMMARY OF THE INVENTION

The present invention has been made in an effort to provide a plasma display apparatus having advantages of fixing a driver IC package more stably and dissipating heat generated from driver ICs more effectively.

A plasma display apparatus according to an embodiment of the present invention includes: a Plasma Display Panel (PDP); a chassis base having the PDP attached to one side thereof and having a Printed circuit Board Assembly (PBA) arranged on another side thereof; a driver IC package adapted to electrically connect to electrodes of the PDP and the PBA, the driver IC package including driver ICs adapted to selectively supply a voltage to the electrodes of the PDP in response to a control signal of the PBA; and cover plates arranged outside of the driver IC package, the cover plates adapted to compress and fix the driver IC package to the chassis base; the cover plates include receiving holes adapted to receive the driver ICs of the driver IC package.

The receiving holes preferably penetrate portions of the cover plates corresponding to the driver ICs. The receiving holes preferably have a shape corresponding to that of the driver ICs. The receiving holes preferably have flat square holes corresponding to a square shape of the driver ICs. Internal dimensions of the receiving holes of the cover plates are preferably greater than external dimensions of the driver ICs. A depth of the receiving holes is preferably greater than a depth of the driver ICs.

The driver IC package preferably includes a Tape Carrier Package (TCP).

The cover plates are preferably elongated to correspond to a plurality of Tape Carrier Packages (TCPs).

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a plasma display apparatus according to a first exemplary embodiment of the present invention.

FIG. 2 is a view of a portion of the plasma display apparatus of FIG. 1.

FIG. 3 is a cross-sectional view of the plasma display apparatus taken along line III-III in FIG. 2.

FIG. 4 is a partial lateral cross-sectional view of the plasma display apparatus of FIG. 3.

FIG. 5 is an exploded perspective view of a plasma display apparatus according to a second exemplary embodiment of the present invention.

### DETAILED DESCRIPTION OF THE INVENTION

The present invention is described below with reference to the accompanying drawings in order for those skilled in the art to be able to implement it. As those skilled in the art would realize, the described embodiments can be modified in various different ways, all without departing from the spirit or scope of the present invention. Wherever possible, the same reference numbers have been used throughout the drawings to refer to the same or like parts.

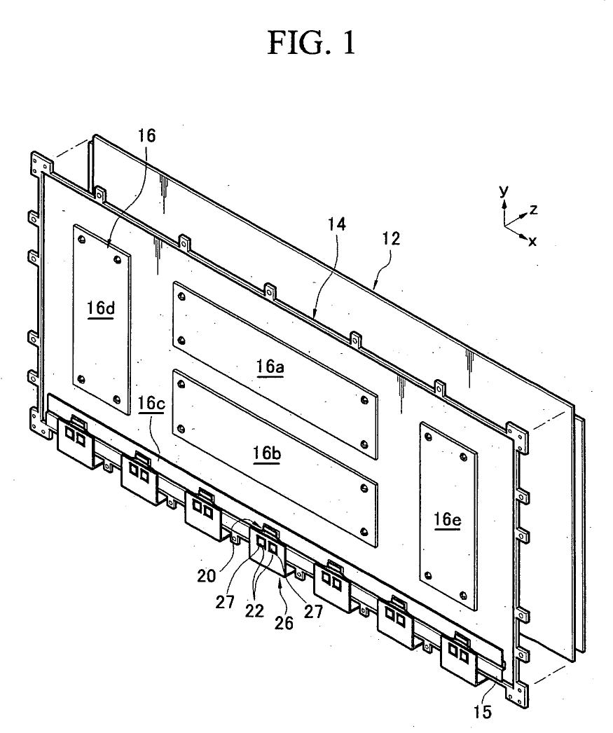

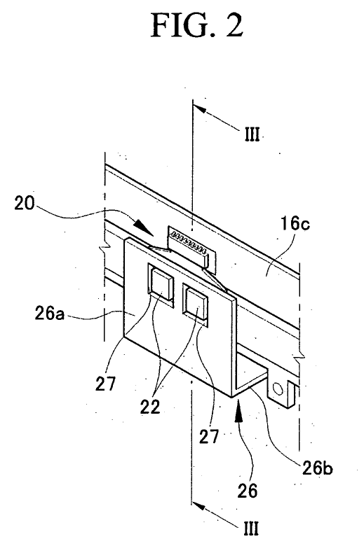

FIG. 1 is an exploded perspective view of a plasma display apparatus according to a first exemplary embodiment of the present invention, and FIG. 2 is a view of a part of the plasma display apparatus of FIG. 1.

The plasma display apparatus is described below with reference to FIGS. 1 and 2. The apparatus includes a PDP 12, a chassis base 14, and a PBA 16.

The PDP 12 is constructed to display an image using a gas discharge. This embodiment of the present invention includes a drive IC package for driving the PDP 12, and a cover plate 26 for fixing the drive IC package and the PDP 12 to the chassis base 14. A detailed description of the PDP 12 has been omitted, as it is well-known to those skilled in the art.

The chassis base 14 is made of an aluminum material, a copper material, an iron material, or the like, that has good durability and thermal conductivity. The PDP 12 is mounted on one side of the chassis base 14, and the PBA 16 for driving the PDP 12 is mounted on the other side of the chassis base 14.

The PBA 16 includes a power supply board 16a that supplies a driving voltage, a logic board 16b that receives an external video signal and generates a driving control signal, an address buffer board 16c that receives the driving control signal from the logic board 16b and supplies an address discharge voltage to address electrodes for selecting a to-be-displayed discharge cell, and a scan board 16d and a sustain board 16e that respectively supply the driving control signal, received from the logic board 16b, to a scan electrode and a sustain electrode.

The address buffer board 16c is electrically connected to the address electrode which extends outward at a lower edge side of the PDP 12 through a driver IC package.

In the present exemplary embodiment, the driver IC package includes a TCP 20 in which driver ICs are mounted on an FPC 21.

Though not shown in the drawings, the scan board 16d and the sustain board 16e are electrically respectively connected to the front ends of the scan electrode and the sustain electrode, which extend outward to the left and right edges of the PDP through the FPC.

Furthermore, a front cover is disposed outside the PDP 12 and a rear cover is disposed outside the chassis base 14. The front and rear covers are combined to form a plasma display apparatus.

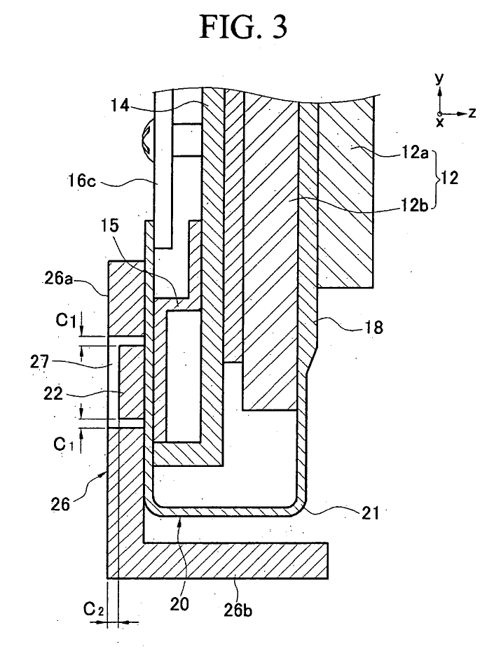

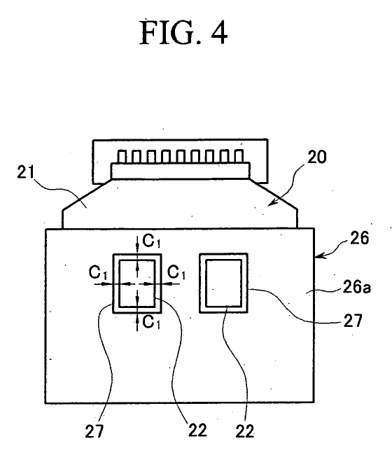

FIG. 3 is a cross-sectional view of the plasma display apparatus taken along line III-III in FIG. 2, and FIG. 4 is a partial lateral cross-sectional view of the plasma display apparatus of FIG. 3.

Referring to FIGS. 3 and 4, the FPC 21 constituting the TCP 20 electrically connects the address electrode 18 and the address buffer board 16c crossing the front and rear sides of the bottom surface of the chassis base 14.

In addition, a portion of the FPC 21 on which driver ICs 22 are mounted is fixed to a reinforcement plate 15 disposed along a lower edge portion of the chassis base 14.

The reinforcement plate 15 is formed to have a certain height (e.g., the same height j as the address buffer board) from the surface of the chassis base 14, thereby reinforcing the strength of the FPC 21 so that the FPC 21 is not bent beyond a specific curvature, and so that heat generated by the driver IC 22 is dissipated through the chassis base 14.

Furthermore, a plurality of the cover plates 26 are disposed outside of the TCP 20, and they function to encompass the reinforcement plate 15 while protecting the TCP 20.

The cover plates 26 are disposed along the lower edge portion of the chassis base 14. The plurality of cover plates 26, each corresponding to the TCP 20, are consecutively disposed at the lower edge portion of the chassis base 14 as shown in FIG. 1.

The cover plates 26 can be formed of an aluminum material, a copper material, an iron material, or the like, which is the same as for the chassis base 14. The cover plates 26 can be fixed to the chassis base 14 by an additional fastening member, such as a setscrew (not shown).

In addition, each of the cover plates 26 includes a first plane 26a opposite to the driver IC 22, and a second plane 26b that extends outward from an outer edge of the first plane 26a to an outer edge of the PDP 12 and that supports the FPC 21. The first and second planes 26a and 26b are integrally formed.

More particularly, receiving holes 27 for receiving the driver IC 22 are formed in the first plane 26a of each of the cover plates 26 so as to penetrate the first plane 26a at a portion corresponding to the driver IC 22.

The receiving holes 27 can be formed to have a shape corresponding to the driver IC 22. For example, the receiving holes 27 can be a flat square shape corresponding to the square shape of the driver IC 22.

Internal dimensions of the receiving holes 27 of the cover plates 26 can be C1 greater than external dimensions of the driver IC 22.

The distance “C1” can be utilized as a predetermined work tolerance such that the driver IC can be smoothly fitted into the receiving hole 27 when assembling the cover plate 26. More particularly, the distance “C1” can prevent vibration and impact, which are transferred from the outside through the cover plates, from being directly transferred.

Through the above construction, the driver IC 22 of the TCP 20 is inserted into the receiving hole 27 formed in the first plane 26a of the cover plate 26. The driver IC 22 directly contacts outside air of the cover plate 26 and facilitates the dissipation of heat by convection.

Meanwhile, a depth of the receiving hole 27 can be greater than a depth of the driver IC 22. That is, a difference between a depth of the receiving hole 27 formed in the cover plates and a depth of the driver IC 22 is C2.

As described above, the receiving hole 27 is formed to have the marginal tolerances C1 and C2 with respect to the driver IC 22, thereby easing the assembly of the cover plate 26 and also preventing vibration and impact from being transferred through the cover plate 26.

Furthermore, an inner lateral surface of the first plane 26a of the cover plate 26 contacts a portion of the FPC 21 in which the driver IC 22 is mounted and firmly compresses the FPC 21 to the reinforcement plate 15.

Therefore, heat that is diffused from the driver IC 22 to the vicinity through the FPC 21 can be smoothly dissipated to the outside through the cover plate 26 touching the FPC 21.

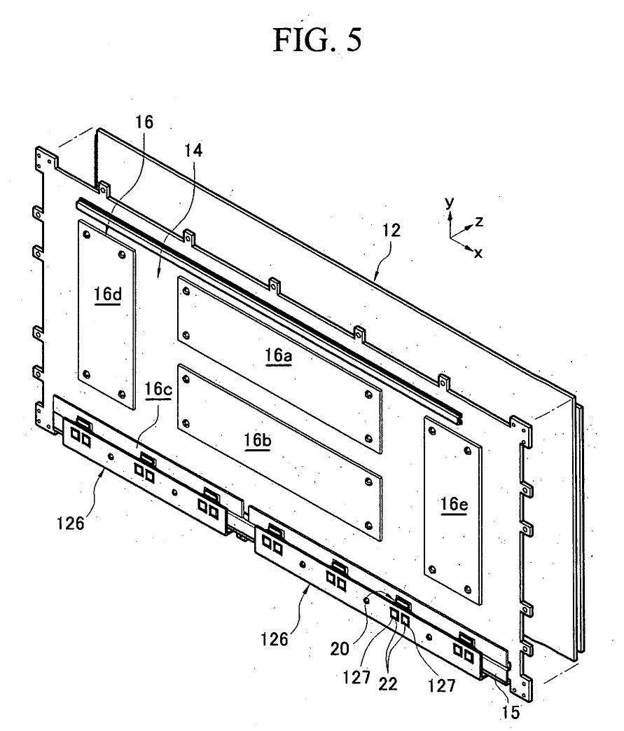

FIG. 5 is an exploded perspective view of a plasma display apparatus according to a second exemplary embodiment of the present invention.

Referring to FIG. 5, cover plates 126 corresponding to a plurality of TCPs are formed to extend along a lower edge portion of a chassis base 14. Furthermore, receiving holes 127 are formed at locations corresponding to driver ICs 22 of each of the TCPs.

The receiving holes 127 have the same shape as the driver ICs 22 and have tolerances C1 and C2 with respect to the driver ICs 22, as described above in connection with the first exemplary embodiment.

As the driver ICs 22 of the TCP are inserted into the receiving holes 127 and are then fully contained therein, they contact a portion of the FPC in which the driver IC is mounted and compress the FPC to the reinforcement plate 15, so that heat can be smoothly dissipated.

Through the above construction, the cover plates 126 of the present exemplary embodiment can simplify the manufacturing and assembly processes since the plurality of cover plates 26 shown in the first exemplary embodiment are elongated. Furthermore, the cover plates 126 can increase a heat dissipation area for dissipating heat that is transferred from the TCP 20 to the outside, so that heat transferred to the cover plates 126 can be more easily dissipated.

As described above, in accordance with the plasma display apparatus according to the present invention, the driver ICs can be fixed more stably even without using the heat dissipating pad. Furthermore, heat generated from the driver IC can be dissipated more effectively.

While the present invention has been described in connection with what is presently considered to be practical exemplary embodiments, it is to be understood that the present invention is not limited to the disclosed embodiments, but, on the contrary, is intended to cover various modifications and equivalent arrangements included within the spirit and scope of the appended claims.

What is claimed is:

1. A plasma display apparatus, comprising:
a Plasma Display Panel (PDP);
a chassis base having the PDP attached to one side thereof and having a Printed circuit Board Assembly (PBA) arranged on another side thereof;
a driver IC package adapted to electrically connect to electrodes of the PDP and the PBA, the driver IC package including driver ICs adapted to selectively supply a voltage to the electrodes of the PDP in response to a control signal of the PBA; and
cover plates arranged outside of the driver IC package, the cover plates adapted to compress and fix the driver IC package to the chassis base;
wherein the cover plates include receiving holes adapted to receive the driver ICs of the driver IC package.

2. The plasma display apparatus of claim 1, wherein the receiving holes penetrate portions of the cover plates corresponding to the driver ICs.

3. The plasma display apparatus of claim 2, wherein the receiving holes have a shape corresponding to that of the driver ICs.

4. The plasma display apparatus of claim 3, wherein the receiving holes have flat square holes corresponding to a square shape of the driver ICs.

5. The plasma display apparatus of claim 1, wherein internal dimensions of the receiving holes of the cover plates are greater than external dimensions of the driver ICs.

6. The plasma display apparatus of claim 3, wherein a depth of the receiving holes is greater than a depth of the driver ICs.

7. The plasma display apparatus of claim 1, wherein the driver IC package comprises a Tape Carrier Package (TCP).

8. The plasma display apparatus of claim 7, wherein the cover plates are elongated to correspond to a plurality of Tape Carrier Packages (TCPs).
